(19) United States
(12) Patent Application Publication
(10) Pub. No.: US 2026/0080265 A1
(43) Pub. Date: Mar. 19, 2026

(54) PERSONALIZED FEDERATED LEARNING METHODS FOR INDUSTRIAL INTERNET OF THINGS TARGETING CLIENT NEEDS

(71) Applicant: CHONGQING UNIVERSITY OF POSTS AND TELECOMMUNICATIONS, Chongqing (CN)

(72) Inventors: Qingqing HUANG, Chongqing (CN); Zhiyao LIU, Chongqing (CN); Yan HAN, Chongqing (CN); Yan ZHANG, Chongqing (CN); Min WEI, Chongqing (CN); Hao WANG, Chongqing (CN); Ping WANG, Chongqing (CN); Haofei XIE, Chongqing (CN)

(73) Assignee: CHONGQING UNIVERSITY OF POSTS AND TELECOMMUNICATIONS, Chongqing (CN)

(21) Appl. No.: 19/313,839

(22) Filed: Aug. 28, 2025

Related U.S. Application Data
(63) Continuation-in-part of application No. PCT/CN2024/137505, filed on Dec. 6, 2024.

(30) Foreign Application Priority Data
Sep. 14, 2024 (CN) 202411292524.2

(51) Int. Cl. G06N 3/098

(52) U.S. Cl. CPC G06N 3/098

(57) ABSTRACT

A personalized federated learning method for industrial Internet of Things targeting client needs is provided. The method includes: issuing, by a server, an initial model to each client as a local model, the local model including a shared layer and a personalized layer; for each client, freezing parameters of the personalized layer and locally training the shared layer based on local industrial data of the client using an orthogonality constraint loss; uploading the trained parameter of the shared layer of each client to the server for averaging and aggregation; sending the aggregated parameter to each client; updating the parameter of the shared layer of each client based on the aggregated parameter; repeating the training and parameter updating process of the shared layer until a count of iterations equals to a count of policy switching communications; training the shared layer and the personalized layer to obtain a trained local model of the client.

### CROSS-REFERENCE TO RELATED APPLICATIONS

This application is a continuation-in-part of International Patent Application No. PCT/CN2024/137505, filed on Dec. 6, 2024, which claims priority to Chinese Patent Application No. 202411292524.2, filed on Sep. 14, 2024, the entire contents of each of which are incorporated herein by reference.

### TECHNICAL FIELD

The present disclosure relates to the field of industrial Internet of Things (IoT) technology, and in particular, relates to a personalized federated learning method for industrial Internet of Things (IoT) targeting client needs.

### BACKGROUND

With the rapid development of industrial Internet of Things (IoT) technology, an increasing number of industrial devices and sensors are capable of collecting and generating data. However, while the industrial IoT is developing rapidly, it is also facing numerous challenges. Due to the lack of secure and effective data-sharing mechanisms, the massive volumes of industrial data generated by existing industrial IoT devices are often exclusively controlled by data holders, forming data silos. This makes it difficult to fully utilize the data, resulting in low data utilization rates. Furthermore, during data-sharing processes, issues such as illegal data trading, data leakage, data misuse, and data abuse lead to the compromise of user privacy.

Federated learning, as an emerging machine learning paradigm, provides a novel solution to address the aforementioned challenges. It employs a federated learning framework to collaboratively train a unified global model without exchanging or sharing industrial data. This approach not only ensures the privacy and security of industrial data but also leverages massive industrial data from diverse sources, thereby enhancing the generalization capability and accuracy of the model.

However, achieving effective federated learning still faces several challenges: 1) although federated learning produces a unified global model, the significantly divergent personalized needs across clients prevent the global model from adapting to all clients; 2) severe data distribution disparities among clients frequently lead to significant weight divergence during the aggregation of federated learning models.

Therefore, it is desired to provide a personalized federated learning method for industrial Internet of Things (IoT) targeting client needs to realize personalized needs of clients.

### SUMMARY

To address the aforementioned technical problems, one or more embodiments of the present disclosure provide a personalized federated learning method for industrial Internet of Things (IoT) targeting client needs. The method includes: S1, constructing a personalized federated learning system comprising N clients and a server, the server being provided with an initial model after initialization of parameters; S2, issuing, by the server, a uniform initial model to each client as a local model

$$\{ {θ}_{g , i}^{0} , {θ}_{p , i}^{0} \}$$

for each client, the local model comprising a shared layer and a personalized layer, wherein

$${θ}_{g , i}^{0}$$

denotes an initial parameter of the shared layer of client i, and

$${θ}_{p , i}^{0}$$

denotes an initial parameter of the personalized layer of the client i; S3, for each client, freezing parameters of the personalized layer, and locally training, by the client, the shared layer of the client based on local industrial data of the client using an orthogonality constraint loss to obtain a parameter

$${\hat{θ}}_{g , i}^{t}$$

of the shared layer of the client after training, wherein t denotes a count of iterations for training the local model; S4, uploading, by each client, the parameter of the shared layer of the client after training to the server for averaging and aggregation, and sending, by the server, an aggregated parameter down to the client, and updating, by each client, the parameter of the shared layer of the client based on the aggregated parameter; and S5, setting a count τ of policy switching communication, if the count t of iterations for training the local model satisfies that t<τ, returning to operation S3, otherwise, locally training, by the client, the shared layer and the personalized layer of the client based on the local industrial data of the client to obtain a trained local model of the client.

The locally training the shared layer includes: S31, inputting, by the client, the local industrial data into the shared layer of the client to generate a feature vector

$${h}_{k}^{i} ,$$

wherein i denotes a client serial number and k denotes an index of the local industrial data; and S32, computing, by the client, a value of a loss function based on the feature vector

$${h}_{k}^{i}$$

of the client, and updating the parameter of the shared layer of the client based on the value of the loss function to obtain the parameter

$${\hat{θ}}_{g , i}^{t}$$

of the shared layer of the client after a t-th iteration of training.

The loss function is L_{g,i}=L_{CIOC,i}+L_{CE,i}, where L_{CIOC,i} denotes a local orthogonality constraint loss of the feature vector

$${h}_{k}^{i} ,$$

and L_{CE,i} denotes a cross-entropy loss of the feature vector

$${h}_{k}^{i} .$$

The local orthogonality constraint loss L_{CIOC,i}=λL_{Push,i}+L_{Pull,i}, where L_{Push,i} denotes a loss of pushing different categories of feature vector spaces apart, L_{Pull,i} denotes a loss of tightening a same category of feature vector spaces, and λ denotes a hyperparameter that measures an importance of L_{Push,i}.

$${L}_{Pull , i} = ( 1 - {{\sum }_{m , s ∈ B}}_{{y}_{m}^{i} = {y}_{s}^{i}} CS ( {h}_{m}^{i} , {h}_{s}^{i} ) ) ,$$

$${L}_{Push , i} = \vert {{\sum }_{m , n ∈ B}}_{{y}_{m}^{i} = {y}_{n}^{i}} CS ( {h}_{m}^{i} , {h}_{n}^{i} ) \vert ,$$

where B denotes a collection of indexes of the local industrial data,

$${y}_{m}^{i} , {y}_{s}^{i} , and {y}_{n}^{i}$$

denote labels of local industrial data indexed as m, s, and n, respectively, of the client i, and CS denotes calculating a cosine similarity.

The locally training, by the client, the shared layer and the personalized layer of the client based on the local industrial data of the client includes: S51, setting a total count T of iterations, and inputting, by the client, the local industrial data of the client into the shared layer of the client to obtain a feature vector; S52, computing, by the client, a local class prototype vector based on the feature vector of the client, updating, by the client, the parameter of the personalized layer of the client based on the local class prototype vector, computing, by the client, the value of the loss function based on the feature vector, and updating, by the client, the parameter of the shared layer of the client based on the value of the loss function; and S53, if the count of iterations of the local model is less than the total count T of iterations, returning to operation S51, otherwise, completing the training of the local model to obtain the trained local model of the client;

The operation of computing a local class prototype vector by the client based on the feature vector

$${O}_{i}^{{C}_{i}}$$

of the client is represented by:

$${O}_{i}^{{C}_{i}} = [ {O}_{i}^{0} , … , {O}_{i}^{c} , … , {O}_{i}^{\vert {C}_{i} \vert - 1} ] ,$$

$${O}_{i}^{c} = \frac{{n}_{i}^{c} {\sum }_{{y}_{k}^{i} = c} {h}_{k}^{i}}{{n}_{i}} , c ∈ {C}_{i} ,$$

where c denotes a local industrial data category, Cᵢ denotes a collection of the local industrial data categories of the client i, |Cᵢ| denotes a count of the local industrial data categories of the client i,

$${O}_{i}^{c}$$

denotes a local class prototype of a c-th category of local industrial data,

$${n}_{i}^{c}$$

denotes a count of the c-th category of local industrial data of the client i,

$${y}_{k}^{i}$$

denotes a label of the local industrial data indexed as k of the client i,

$${h}_{k}^{i}$$

denotes a feature vector corresponding to the local industrial data indexed as k outputted by the shared layer of the client i, and nᵢ denotes a count of the local industrial data of the client i;

The operation of updating the parameter of the personalized layer of the client by the client based on the local class prototype vector is represented by:

$${θ}_{p , i}^{t + 1} ← ( 1 - {ρ}_{( v )} ) {θ}_{p , i}^{t} + {ρ}_{( v )} {O}_{i}^{{C}_{i} , t} , t \geq τ ,$$

where v denotes a fixed constant, ρ₍ᵥ₎ denotes a smoothing parameter, and

$${O}_{i}^{{C}_{i} , t}$$

denotes a local class prototype vector during the t-th iteration of training.

The smoothing parameter is represented by:

$${ρ}_{( v )} = ( 1 - v ) ( sin ( \frac{π ( t - T )}{2 ( T - τ )} ) + 1 ) .$$

The shared layer comprises a convolutional layer, a pooling layer, a normalization layer, and an activation layer, and the personalized layer comprises a fully connected layer and an activation layer.

Some embodiments of the present disclosure include, but are not limited to, at least the following beneficial effects.

1. Some embodiments of the present disclosure take the personalized needs of clients into account and construct a local orthogonality constraint loss function for feature vectors output by the client's shared layer by leveraging the orthogonal characteristics of feature space vectors to train the shared layer, thereby alleviating the weight divergence caused during federated learning aggregation. 2. Some embodiments of the present disclosure take the personalized needs of clients into account and apply the client's local industrial data information to guide the personalized layer of the corresponding client, thereby improving the personalized classification capability of each client.

### BRIEF DESCRIPTION OF THE DRAWINGS

The present disclosure is further described in terms of exemplary embodiments. These exemplary embodiments are described in detail with reference to the drawings. The drawings are not scaled. These embodiments are non-limiting exemplary embodiments, in which like reference numerals represent similar structures throughout the several views of the drawings, and wherein:

FIG. 1 is a flowchart illustrating an exemplary personalized federated learning process for industrial Internet of Things (IoT) targeting client needs according to some embodiments of the present disclosure.

### DETAILED DESCRIPTION

The technical solutions in the embodiments of the present disclosure will be clearly and completely described below in conjunction with the accompanying drawings in the embodiments of the present disclosure. Obviously, the described embodiments are only a part of the embodiments of the present disclosure, rather than all the embodiments. Based on the embodiments in the present disclosure, all other embodiments obtained by those of ordinary skill in the art without making creative efforts shall fall within the protection scope of the present disclosure.

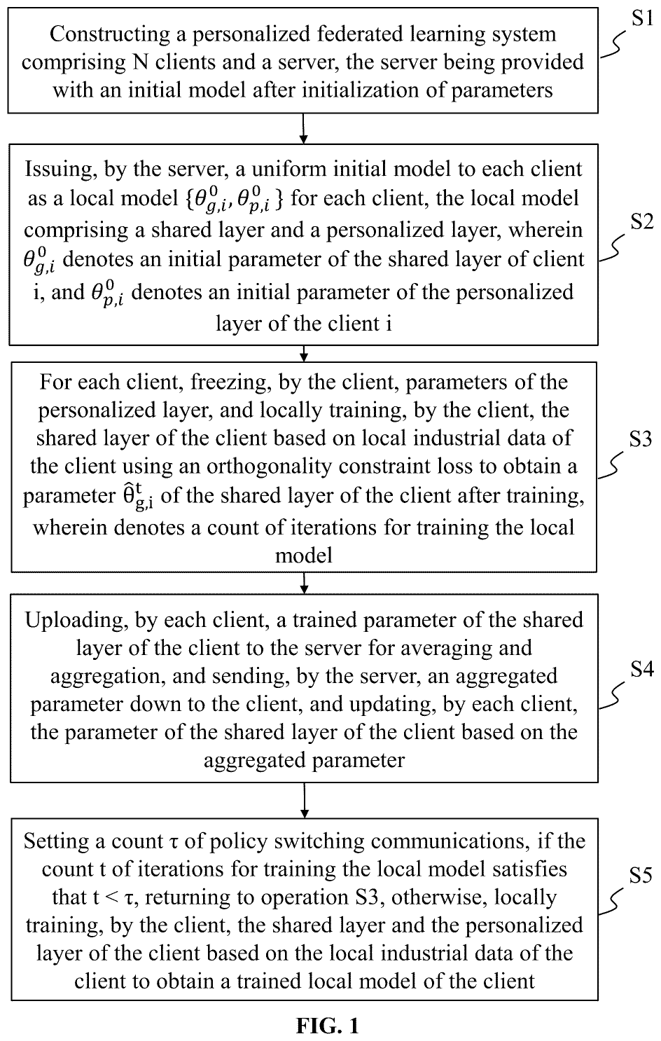

FIG. 1 is a flowchart illustrating an exemplary personalized federated learning process for industrial Internet of Things (IoT) targeting client needs according to some embodiments of the present disclosure.

As shown in FIG. 1, a personalized federated learning method for industrial Internet of Things (IoT) targeting client needs is provided. In some embodiments, the method may be executed by a processor (e.g., a processor of a client and a processor of a server). The method may include the following operations.

In S1, a personalized federated learning system comprising N clients and a server may be constructed. The server is provided with an initial model after initialization of parameters.

The client refers to a device required to participate in a federated learning task. For example, the clients include devices that need to update parameters of their local models through federated learning. In some embodiments, the clients may be industrial IoT sensors, smart devices, or the like. The count N of clients may be determined based on actual needs. For example, the value of N may be defined by selecting all or a portion of a plurality of clients in the industrial IoT system.

The server refers to a local or remote server. The server may be composed of one or more communicatively connected computer systems in a centralized or distributed manner. In some embodiments, the server may store client information corresponding to each client. The client information may include, but is not limited to, client serial number, client identity information (e.g., a medium/media access control (MAC) address, an ID identifier, etc.), and hardware configuration information (e.g., a memory capacity, a count of processor cores, etc.).

In some embodiments, the processor may be integrated into each client and the server. The processor refers to a hardware unit configured to execute instructions. The processor may include one or more processing cores to process data in parallel. For example, the processor may be a central processing unit (CPU), a graphics processing unit (GPU), an application-specific integrated circuit (ASIC), or other hardware devices with computational capabilities. The processor may also include caches, registers, and other computational resources to increase processing efficiency. The processor can work in concert with other hardware components (e.g., memory, input/output interfaces, etc.) to accomplish data reading, processing, and output. The processor may perform a variety of computational tasks, including, but not limited to, data encoding, feature extraction, model training, or the like.

In some embodiments, a personalized federated learning system may be constructed by establishing communication connections between a plurality of clients (e.g., N clients) and the server via a network. The network may be a wireless network, which is used to facilitate the exchange of information and/or data between the clients and the server. For example, each client may upload data and/or information to the server via the network, and the server may also send data and/or information to the clients via the network.

The initial model refers to a model used at the beginning of federated learning, which may be a machine learning model generated by a machine learning algorithm. For example, the initial model may be a convolutional neural network (CNN) model or any other deep neural network, or a combination thereof. Parameters of the initial model may be randomly initialized. In some embodiments, the initial model may be obtained through transfer learning. For example, parameters of the initial model for the current federated learning may be determined based on parameters (e.g., parameters of a shared layer) obtained from a previous federated learning.

In S2, a uniform initial model may be issued to each client as a local model

$$\{ {θ}_{g , i}^{0} , {θ}_{p , i}^{0} \}$$

by the server. In some embodiments, local model is represented as

$${θ}_{i}^{0} = \{ {θ}_{g , i}^{0} , {θ}_{p , i}^{0} ∈ {R}^{C \times d} \} .$$

To adapt to the personalized needs of the clients, the local model may be decoupled into a shared layer and a personalized layer, wherein

$${θ}_{i}^{0}$$

denotes an initial parameter of an i-th client,

$${θ}_{g , i}^{0}$$

denotes an initial parameter of the shared layer of client i, and

$${θ}_{p , i}^{0}$$

denotes an initial parameter of the personalized layer of the client i, R^{C×d} denotes a parameter space, C denotes a count of local industrial data categories, d denotes an output dimension of feature vectors from the shared layer. More descriptions regarding the shared layer and the personalized layer may be found later in the present disclosure.

In S3, each client freezes parameters of the personalized layer of the client, and to address the personalized need of the client, the client performs a t-th iteration of local training on the shared layer of the client using an orthogonality constraint loss based on local industrial data of the client to obtain a parameter

$${\hat{θ}}_{g , i}^{t}$$

of the shared layer of the client after the t-th iteration of local training, wherein t denotes a count of iterations for training the local model.

The local industrial data refers to data acquired by each client in actual application scenarios. The local industrial data may include, but is not limited to, images, text, and signals. For example, in an industrial fault diagnosis application, the local industrial data may include vibration signals from a gearbox of the client. In some embodiments, the local industrial data may be stored in a storage device of the client. In some embodiments, the local industrial data may be encrypted before being stored on the server.

In S4, each client uploads the trained parameter of the shared layer of the client to the server for averaging and aggregation. The server sends an aggregated parameter down to each client. Each client updates the parameter of the shared layer of the client based on the aggregated parameter.

The trained parameter of the shared layer of the client refers to the parameter

$${\hat{θ}}_{g , i}^{t}$$

of the shared layer after completion of training. In some embodiments, the server may perform averaging and aggregation on the trained parameter

$${\hat{θ}}_{g , i}^{t}$$

of the shared layer uploaded by each client using an average aggregation algorithm to obtain the aggregated parameter. After each client updates the parameter of the shared layer based on the aggregated parameter, a final parameter

$${θ}_{g , i}^{t}$$

of the shared layer of each client after the t-th iteration of training may be obtained.

The parameter of the shared layer refers to a common parameter shared by the shared layers of the local models of the clients. That is, the parameters of the shared layers in the local models of the clients are identical. In some embodiments, after each client updates the parameter of the shared layer based on the aggregated parameter, a trained shared layer may be obtained.

In S5, a count τ of policy switching communications may be set. If the count t of iterations for training the local model satisfies that t<τ, it returns to perform operation S3; otherwise, to address the personalized need of each client, the client performs the local training on the shared layer and the personalized layer of the client based on the local industrial data of the client to obtain a trained local model of the client.

The personalized need of a client refers to a need that can distinguish the client from other clients. The personalized need of the client may be determined based on, but be not limited to, a type of the client (e.g., a type of the industrial IoT sensor), a category of acquired data (e.g., a category of the local industrial data), the quantity of data, a task of the client (e.g., gearbox fault diagnosis), the production environment, etc. For example, the personalized need of the client i may be the fault identification and/or diagnosis of key mechanical components (e.g., gearboxes).

The count of policy switching communications may be configured to control the progress of federated learning. It is understood that the personalized federated learning process for industrial IoT targeting client needs provided according to some embodiments of the present disclosure may be divided into a first learning phase and a second learning phase. The first learning phase is a training phase for the shared layer of each client, and the second learning phase is the joint training phase for both the shared layer and the personalized layer of each client. When the count t of iterations for training the local model satisfies that t is less than τ, it indicates that the first learning phase (i.e., operation S3 to operation S4) needs to be maintained. In some embodiments, the count of policy switching communications τ may be preset by technicians based on experience.

In some embodiments, the server may adjust the count of policy switching communications according to a difference degree of the aggregated parameter. The difference degree of the aggregated parameter is used to evaluate a degree of variation between aggregated parameters from a plurality of aggregation operations. In some embodiments, the server may determine the difference degree of the aggregated parameter based on a difference between the currently aggregated parameter and the aggregated parameter from a preceding aggregation. Merely by way of example, the server may determine difference degree by comparing the aggregated parameter in the t-th iteration of training with the aggregated parameter in the (t−1)-th iteration of training. The difference degree may be determined based on a cosine similarity between the aggregated parameters from the two aforementioned aggregation operations. In response to determining that the difference degree is less than a preset difference threshold, the count of policy switching communications is reduced, thereby decreasing the count of iterations of training in the first learning phase.

Considering that the first learning phase requires the server to aggregate the parameters of the shared layers uploaded by the clients and send the aggregated parameter to each client, in some embodiments of the present disclosure, by analyzing the difference degree of the aggregated parameter to adjust the count of policy switching communications, it is possible to adapt to the effectiveness of the first learning phase and reduce the consumption of communication and computing resources.

In some embodiments, to address the personalized need of each client and perform the local training on the shared layer of the client based on the local industrial data of the client using the orthogonality constraint loss, the client may perform operation S31-operation S32.

In S31, the client inputs the local industrial data into the shared layer of the client to generate a feature vector

$${h}_{k}^{i} ,$$

wherein i denotes a client serial number and k denotes an index of the local industrial data.

In S32, the client computes a value of a loss function based on the feature vector

$${h}_{k}^{i}$$

of the client, and updates the parameter of the shared layer of the client based on the value of the loss function to obtain the parameter

$${\hat{θ}}_{g , i}^{t}$$

of the shared layer of the client after the t-th iteration of training.

In some embodiments, for each client, the client may update a parameter

$${θ}_{g , i}^{t - 1}$$

of the shared layer of the client based on the value of the loss function to obtain the parameter

$${\hat{θ}}_{g , i}^{t}$$

of the shared layer of the client after the t-th iteration of training.

In some embodiments, the loss function is represented by the following formula:

$${L}_{g , i} = {L}_{CIOC , i} + {L}_{CE , i} .$$

A parameter updating process is represented by the following formula:

$${\hat{θ}}_{g , i}^{t} ← {\hat{θ}}_{g , i}^{t - 1} - {η}_{t - 1} ( \frac{\partial {L}_{CIOC}}{\partial {θ}_{g , i}^{t - 1}} + \frac{\partial {L}_{CE}}{\partial {θ}_{g , i}^{t - 1}} ) ,$$

where L_{CIOC,i} denotes a local orthogonality constraint loss of the feature vector

$${h}_{k}^{i} ,$$

L_{CE,i} denotes a cross-entropy loss of the feature vector

$${h}_{k}^{i} ,$$

and ηₜ₋₁ denotes a learning rate at the (t−1)-th iteration of training.

In some embodiments, the cross-entropy loss L_{CE,i} is represented by the following formula:

$${L}_{CE , i} = - \frac{1}{{n}_{i}} {\sum }_{k = 1}^{{n}_{i}} {\sum }_{c = 0}^{\vert {C}_{i} \vert - 1} \{ {y}_{k}^{i} = c \} log \frac{exp ( {( {h}_{k}^{i} )}^{T} {w}_{c} )}{{\sum }_{j = 0}^{\vert {C}_{i} \vert - 1} exp ( {( {h}_{k}^{i} )}^{T} {w}_{j} )} ,$$

where nᵢ denotes a size of data (i.e., the local industrial data) of the client i,

$${y}_{k}^{i}$$

denotes a label of data indexed as k of the client i,

$${h}_{k}^{i}$$

denotes a feature vector corresponding to the data indexed as k, c denotes a local industrial data category, w_{c} denotes a weight of a local industrial data category c, wⱼ denotes a weight of a local industrial data category j, and |Cᵢ| denotes a count of the local industrial data categories of the client i.

In some embodiments, the local orthogonality constraint loss L_{CIOC,i} represented by the following formula:

$${L}_{CIOC , i} = λ {L}_{Push , i} + {L}_{Pull , i} ,$$

where L_{Push,i} denotes a loss of pushing different categories of feature vector spaces apart, L_{Pull,i} denotes a loss of tightening a same category of feature vector spaces, and λ denotes a hyperparameter that measures the importance of L_{Push,i}, and λ may be preset by technical personnel.

In some embodiments, the loss L_{Push,i} and the loss L_{Pull,i} may be represented by the following formulas:

$${L}_{Pull , i} = ( 1 - {\sum }_{m , s ∈ B} CS ( {h}_{m}^{i} , {h}_{s}^{i} ) ) , {y}_{m}^{i} = {y}_{s}^{i}$$

$${L}_{Push , i} = \vert {\sum }_{m , n ∈ B} CS ( {h}_{m}^{i} , {h}_{n}^{i} ) \vert , {y}_{m}^{i} = {y}_{n}^{i}$$

where B denotes a collection of indexes of the local industrial data,

$${y}_{m}^{i} , {y}_{s}^{i} , and {y}_{n}^{i}$$

denote labels of local industrial data indexed as m, s, and n, respectively, of the client i, and CS denotes calculating a cosine similarity.

Pushing different categories of feature vector spaces apart is characterized as distinguishing feature vectors of different categories. In some embodiments, the processor may adjust the value of λ based on a preset model evaluation metric. The preset model evaluation metric may include global balanced accuracy (GBA), personalized balanced accuracy (PBA), personalized distributional embedding accuracy (PDA), or the like, or any combination thereof.

In some embodiments, the processor may adjust the value of/based on a value of GBA. For example, if the value of GBA is less than a preset GBA threshold, the processor may increase 1 to forcibly enhance the contribution of L_{Push,i} to the local orthogonality constraint loss, thereby enabling the trained shared layer to better discriminate feature vectors across different categories.

In some embodiments, the processor may adjust the value of A based on a value of PDA and/or a value of PBA. For example, if the value of PDA (e.g., an average of values of PDA corresponding to all clients) is less than a preset PDA threshold, the value of λ may be increased to force the shared layer to more fully learn the variations in the private local industrial data of each client, so that the trained shared layer can be made to better distinguish the feature vectors of different categories in the private local industrial data, thereby improving the generalization ability of the shared layer. If the value of PBA is lower than a preset PBA threshold, the value of λ may also be increased.

In some embodiments of the present disclosure, considering a correlation relationship between the shared layer and the personalized layer, by combining one or a combination of model evaluation metrics (e.g., GBA, PBA, and PDA) to adjust the local orthogonality constraint loss function of the shared layer (e.g., adjusting the hyperparameter λ), it is possible to improve the generalization ability of the shared layer while ensuring the performance of the overall model. Meanwhile, it also enhances the accuracy of the shared layer in classifying the private local industrial data of each client.

It should be noted that a processor (e.g., a processor of the client) may test the local model of each client based on a test dataset to determine the aforementioned values of the GBA, PBA, and PDA. More descriptions regarding the GBA, the PBA, and the PDA may be found later in the present disclosure.

In some embodiments of the present disclosure, the client utilizes orthogonal characteristics of feature space vectors through the local orthogonality constraint loss function to alleviate weight divergence among different clients, preventing the model from learning data features that are overly biased toward certain clients, thereby ensuring the generalization ability of the model.

In some embodiments, for each client, locally training the shared layer and the personalized layer of each client based on the local industrial data of the client for addressing personalized needs includes operations S51-S53.

In S51, a total count T of iterations may be set, and each client inputs the local industrial data of the client into the shared layer of the client to obtain a feature vector.

In S52, the client computes a local class prototype vector based on the feature vector of the client, and updates the parameter of the personalized layer of the client based on the local class prototype vector. The client computes the value of the loss function based on the feature vector, and updates the parameter of the shared layer of the client based on the value of the loss function.

In S53, if the count of iterations of the local model is less than the total count T of iterations, it returns to perform operation S51; otherwise, the training of the local model may be completed to obtain the trained local model of the client.

The total count T of iterations may be preset by technicians based on experience. In some embodiments, for different clients, the total count T of iterations may be the same or different. In some embodiments, the processor (e.g., the processor the server) may adjust the total count of iterations for different clients (e.g., client i) based on a data volume of local industrial data and the computational capability of client i, thereby determining the total count Tᵢ of iterations corresponding to client i. The computational capability of a client may be determined based on the client information corresponding to each client (such as hardware configuration information). For example, if client i has a large data volume and strong computational capability, its corresponding total count Tᵢ of iterations may be set larger to make the training more sufficient; if client i has relatively sparse data and weaker computational capability, its corresponding total count Tᵢ of iterations may be set smaller to improve training efficiency while preventing excessive load on client i.

In some embodiments of the present disclosure, dynamically adjusting the total count of iterations based on the actual data volume of different clients and the computational capability of the clients considers the actual resource configuration of each client while ensuring data privacy, which can improve the local training efficiency of individual clients and the overall efficiency of federated learning.

In some embodiments, the local class prototype vector

$${O}_{i}^{{c}_{i}}$$

being computed by the client based on the feature vector of the client is represented by:

$${O}_{i}^{{C}_{i}} = [ {O}_{i}^{0} , … , {O}_{i}^{c} , … , {O}_{i}^{\vert {C}_{i} \vert - 1} ] ,$$

$${O}_{i}^{c} = \frac{{n}_{i}^{c} {\sum }_{{y}_{k}^{i} = c} {h}_{k}^{i}}{{n}_{i}} , c ∈ {C}_{i} ,$$

where c denotes a local industrial data category, Cᵢ denotes a collection of the local industrial data categories of the client i, |Cᵢ| denotes a count of the local industrial data categories of the client i,

$${O}_{i}^{c}$$

denotes a local class prototype of a c-th category of local industrial data,

$${n}_{i}^{c}$$

denotes a count of the c-th category of local industrial data of the client i,

$${y}_{k}^{i}$$

denotes a label of the local industrial data indexed as k of the client i,

$${h}_{k}^{i}$$

denotes a feature vector corresponding to the local industrial data indexed as k outputted by the shared layer of the client i, and nᵢ denotes a count of the local industrial data of the client i.

The local class prototype vector characterizes a typical feature of the local industrial data of each client (e.g., client i). The local class prototype vectors corresponding to different clients reflect personalized variations in local industrial data among the different clients.

In some embodiments, for each client, the parameter of the personalized layer of the client being updated based on the local class prototype vector is represented by:

$${θ}_{p , i}^{t + 1} ← ( 1 - {ρ}_{( v )} ) {θ}_{p , i}^{t} + {ρ}_{( v )} {O}_{i}^{{C}_{i} , t} , t \geq τ ,$$

$${θ}_{p , i}^{τ} = {θ}_{p , i}^{0} ,$$

$${ρ}_{( v )} = ( 1 - v ) ( sin ( \frac{π ( t - T )}{2 ( T - τ )} ) + 1 ) ,$$

where t denotes a current iteration of training, v denotes a fixed constant, which can be set as 0.9, ρ₍ᵥ₎ denotes a smoothing parameter, and

$${O}_{i}^{{C}_{i} , t}$$

denotes a local class prototype vector during the t-th iteration of training.

The process of updating the parameter of the shared layer of each client based on the loss function value is consistent with that in operation S32.

In some embodiments of the present disclosure, by performing training on the personalized layer based on the shared layer, data difference characteristics among different clients can be further adapted to on the basis of ensuring the generalization ability of the local model, thereby meeting the personalized needs of different clients.

In some embodiments, for each client, the trained local model may be stored in a storage device of the client, and the client may analyze and/or process the acquired industrial data using the trained local model. Merely by way of example, the client may input the acquired industrial data (e.g., vibration signals of components like gears and bearings) into the trained local model to obtain a prediction result output by the trained local model. For example, the prediction result may include a healthy state, a gear tooth breakage fault, a bearing inner race fault, or the like.

In some embodiments, the personalized federated learning process for industrial IoT targeting client needs provided according to some embodiments of the present disclosure may be executed according to a preset time period. The preset time period may be weekly, monthly, or the like. For example, the processor may execute the aforementioned operation S1 to operation S5 based on the preset time period to implement one round of personalized federated learning. After each round of personalized federated learning is completed, each client obtains a trained local model. In the personalized federated learning conducted over a plurality of preset time periods, the initial parameters of the shared layer corresponding to the uniform initial model issued by the server to each client may be the trained parameters obtained from the previous round of personalized federated learning, thereby ensuring the continuity of federated learning.

In some embodiments, the shared layer includes: 4 convolutional layers, 2 pooling layers, 4 normalization layers, and 4 activation layers, wherein convolution kernels of the convolutional layers are 7, 5, 3, and 3, respectively, and counts of output neurons are 4096, 2048, 2048, and 2048, respectively. The personalized layer includes: 3 fully connected layers and 2 activation layers, wherein the 3 fully connected layers contain 1024, 256, and 10 hidden neurons, respectively.

In some embodiments, the industrial data may include a vibration signal of mechanical critical components (e.g., gearboxes) of each client. The vibration signal may be acquired through a parallel gearbox gear/bearing experiment on a data distribution service (DDS) test platform. The acquired vibration signal includes a vibration signal in a horizontal direction and a vibration signal in a vertical direction. The data sampling frequency is 25.6 kHz, and a total of 10 operational states are sampled. Each sampling session lasts 56.25 seconds, and 2500 pieces of vibration data are collected per session. The acquired data is then distributed to different clients according to a Dirichlet distribution to simulate real-world conditions.

TABLE 1
Description of dataset

| | | Fault Data |
|---|---|---|
| Label | Fault Description | Shape |
| 0 | Healthy State | [2000, 1, 1024] |
| 1 | Gear Root Crack Fault | [2000, 1, 1024] |
| 2 | Gear Tooth Breakage Fault | [2000, 1, 1024] |
| 3 | Gear Surface Wear Fault | [2000, 1, 1024] |
| 4 | Gear Missing Tooth Fault | [2000, 1, 1024] |
| 5 | Gear Eccentricity Fault | [2000, 1, 1024] |
| 6 | Bearing Outer Race Fault | [2000, 1, 1024] |
| 7 | Bearing Inner Race Fault | [2000, 1, 1024] |
| 8 | Bearing Rolling Element Fault | [2000, 1, 1024] |
| 9 | Bearing Compound Fault | [2000, 1, 1024] |

To comparatively analyze the effectiveness of the method provided in some embodiments of the present disclosure, in some embodiments, federated averaging (FedAvg) is used as a baseline method for comparison. Three personalized federated learning metrics are used to evaluate model performance: GBA, PBA, and PDA.

$$GBA = \frac{1}{{N}_{x}} {\sum }_{x}^{{N}_{x}} 1 ( {y}_{x} = {\hat{y}}_{x}^{i} ) ,$$

$$PBA = \frac{1}{N} {\sum }_{i}^{N} \frac{{\sum }_{x}^{{N}_{x}} 1 ( {y}_{x} = {\hat{y}}_{x}^{i} )}{{N}_{x}} ,$$

$$PDA = \frac{1}{N} {\sum }_{i}^{N} \frac{{\sum }_{x}^{{N}_{x}} {P}_{i} ( {y}_{x} ) 1 ( {y}_{x} = {\hat{y}}_{x}^{i} )}{{\sum }_{x}^{{N}_{x}} {P}_{i} ( {y}_{x} )} ,$$

where yₓ denotes a label of an x-th sample,

$${\hat{y}}_{x}^{i}$$

denotes a fault prediction result of the x-th sample by the local model of the i-th client, Nₓ denotes a total count of samples, and Pᵢ(yₓ) denotes a probability distribution of fault categories of the i-th client. The experimental comparison results are shown in Table 2

TABLE 2
Comparison of gearbox fault diagnosis metrics across
different personalized federated learning methods

| Dirichlet | | | |
|---|---|---|---|
| distribution | | Proposed | |
| (Dir) | Metric | method | FedAvg |
| Dir(0.3) | GBA | 83.22 | 73.01 |
| | PBA | 83.69 | 68.52 |
| | PDA | 82.49 | 69.25 |
| Dir(1.0) | GBA | 90.85 | 78.90 |
| | PBA | 89.26 | 76.40 |
| | PDA | 86.49 | 73.68 |

As shown in Table 2, in the experimental results, the proposed method provided in some embodiments of the present disclosure is significantly superior to the baseline methods, which proves that the proposed method can significantly improve the personalized fault diagnosis performance of different clients under the condition of severe label distribution disparities among clients.

The aforementioned embodiments provide further detailed elaboration of the objectives, technical solutions, and advantages of the present disclosure. It shall be understood that these embodiments represent only preferred implementations of the present disclosure and are not intended to limit its scope. Any alterations, equivalent substitutions, or improvements made within the spirit and principles of the present disclosure shall fall within the protection scope of the present disclosure.

What is claimed is:

1. A personalized federated learning method for industrial Internet of Things (IoT) targeting client needs, comprising:
S1, constructing a personalized federated learning system comprising N clients and a server, the server being provided with an initial model after initialization of parameters;
S2, issuing, by the server, a uniform initial model to each client as a local model
$$\{ {θ}_{g , i}^{0} , {θ}_{p , i}^{0} \}$$
for each client, the local model comprising a shared layer and a personalized layer, wherein
$${θ}_{g , i}^{0}$$
denotes an initial parameter of the shared layer of client i, and
$${θ}_{p , i}^{0}$$
denotes an initial parameter of the personalized layer of the client i;
S3, for each client, freezing, by the client, parameters of the personalized layer, and locally training, by the client, the shared layer of the client based on local industrial data of the client using an orthogonality constraint loss to obtain a parameter
$${\hat{θ}}_{g , i}^{t}$$
of the shared layer of the client after training, wherein t denotes a count of iterations for training the local model, and locally training the shared layer comprises:
S31, inputting, by the client, the local industrial data into the shared layer of the client to generate a feature vector
$${h}_{k}^{i} ,$$
wherein i denotes a client serial number and k denotes an index of the local industrial data;
S32, computing, by the client, a value of a loss function based on the feature vector
$${h}_{k}^{i}$$
of the client, and updating the parameter of the shared layer of the client based on the value of the loss function to obtain the parameter
$${\hat{θ}}_{g , i}^{t}$$
of the shared layer of the client after a t-th iteration of training, wherein
the loss function is L_{g,i}=L_{CIOC,i}+L_{CE,i}, where L_{CIOC,i} denotes a local orthogonality constraint loss of the feature vector
$${h}_{k}^{i} ,$$
and L_{CE,i} denotes a cross-entropy loss of the feature vector
$${h}_{k}^{i} ,$$
and
the local orthogonality constraint loss L_{CIOC,i}=λL_{Push,i}+L_{Pull,i}, where L_{Push,i} denotes a loss of pushing different categories of feature vector spaces apart, L_{Pull,i} denotes a loss of tightening a same category of feature vector spaces, and λ denotes a hyperparameter that measures an importance of L_{Push,i};
S4, uploading, by each client, a trained parameter of the shared layer of the client to the server for averaging and aggregation, and sending, by the server, an aggregated parameter down to the client, and updating, by each client, the parameter of the shared layer of the client based on the aggregated parameter; and
S5, setting a count τ of policy switching communications, if the count t of iterations for training the local model satisfies that t<τ, returning to operation S3, otherwise, locally training, by the client, the shared layer and the personalized layer of the client based on the local industrial data of the client to obtain a trained local model of the client.

2. The method of claim 1, wherein
$${L}_{Pull , i} = ( 1 - {\sum }_{{m , s ∈ B}_{{y}_{m}^{i} = {y}_{s}^{i}}} CS ( {h}_{m}^{i} , {h}_{s}^{i} ) ) ,$$
$${L}_{Push , i} = \vert {\sum }_{{m , n ∈ B}_{{y}_{m}^{i} = {y}_{n}^{i}}} CS ( {h}_{m}^{i} , {h}_{n}^{i} ) \vert ,$$
where B denotes a collection of indexes of the local industrial data,
$${y}_{m}^{i} , {y}_{s}^{i} , and {y}_{n}^{i}$$
denote labels of local industrial data indexed as m, s, and n, respectively, of the client i, and CS denotes calculating a cosine similarity.

3. The method of claim 1, wherein the locally training, by the client, the shared layer and the personalized layer of the client based on the local industrial data of the client comprises:
S51, setting a total count T of iterations, and inputting, by the client, the local industrial data of the client into the shared layer of the client to obtain a feature vector;
S52, computing, by the client, a local class prototype vector based on the feature vector of the client, updating, by the client, the parameter of the personalized layer of the client based on the local class prototype vector, computing, by the client, the value of the loss function based on the feature vector, and updating, by the client, the parameter of the shared layer of the client based on the value of the loss function; and
S53, if the count of iterations of the local model is less than the total count T of iterations, returning to operation S51, otherwise, completing the training of the local model to obtain the trained local model of the client.

4. The method of claim 3, wherein computing, by the client, a local class prototype vector based on the feature vector
$${O}_{i}^{{c}_{i}}$$
of the client comprises:
$${O}_{i}^{{C}_{i}} = [ {O}_{i}^{0} , … , {O}_{i}^{c} , … , {O}_{i}^{\vert {C}_{i} \vert - 1} ] ,$$
$${O}_{i}^{c} = \frac{{n}_{i}^{c} {\sum }_{{y}_{k}^{i} = c} {h}_{k}^{i}}{{n}_{i}} , c ∈ {C}_{i} ,$$
where c denotes a local industrial data category, Cᵢ denotes a collection of the local industrial data categories of the client i, |Cᵢ| denotes a count of the local industrial data categories of the client i,
$${O}_{i}^{c}$$
denotes a local class prototype of a c-th category of local industrial data,
$${n}_{i}^{c}$$
denotes a court of the c-th category of local industrial data of the client i,
$${y}_{k}^{i}$$
denotes a label of the local industrial data indexed as k of the client i,
$${h}_{k}^{i}$$
denotes a feature vector corresponding to the local industrial data indexed as k outputted by the shared layer of the client i, and nᵢ denotes a count of the local industrial data of the client i.

5. The method of claim 3, wherein the updating, by the client, the parameter of the personalized layer of the client based on the local class prototype vector comprises:
$${θ}_{p , i}^{t + 1} ← ( 1 - {ρ}_{( v )} ) {θ}_{p , i}^{t} + {ρ}_{( v )} {O}_{i}^{{C}_{i} , t} , t \geq τ ,$$
where v denotes a fixed constant, ρ₍ᵥ₎ denotes a smoothing parameter, and
$${O}_{i}^{{C}_{i} , t}$$
denotes a local class prototype vector during the t-th iteration of training.

6. The method of claim 5, wherein the smoothing parameter
$${ρ}_{( v )} = ( 1 - v ) ( sin ( \frac{π ( t - T )}{2 ( T - τ )} ) + 1 ) .$$

7. The method of claim 1, wherein the shared layer comprises a convolutional layer, a pooling layer, a normalization layer, and an activation layer, and the personalized layer comprises a fully connected layer and an activation layer.
